(19) United States
(12) Patent Application Publication
(10) Pub. No.: US 2014/0092235 A1
(43) Pub. Date: Apr. 3, 2014

(54) DOWNHOLE CAMERA AND LIGHTING APPARATUS AND METHOD

(71) Applicant: ABRADO WELLBORE SERVICES, LLC, HOUSTON, TX (US)

(72) Inventors: FRANK CULLY FIRMIN, LAFAYETTE, LA (US); MARSHAL HARRIS, Houston, TX (US); PHILIP SCHULTZ, KATY, TX (US); CHRISTOPHER MEYERS, YOUNGSVILLE, LA (US)

(21) Appl. No.: 14/043,198

(22) Filed: Oct. 1, 2013

Related U.S. Application Data
(60) Provisional application No. 61/708,084, filed on Oct. 1, 2012.

(51) Int. Cl. H04N 7/18

(52) U.S. Cl. CPC H04N 7/18
USPC 348/85

(57) ABSTRACT

An illuminated camera apparatus can be used downhole in wellbores or other environments lacking ambient or available light. Light generated by a light emitting diode or other light source is pointed or reflected toward a glass light pipe that conveys such light past a camera or other visual image sensor. The conveyed light is diffused to evenly illuminate the surrounding environment into the field of view of the camera or other visual image sensor. At least one heat sink can be provided to absorb and/or retain heat, and isolate such heat from thermally sensitive components.

### CROSS REFERENCES TO RELATED APPLICATION

Priority of U.S. Provisional Patent Application Ser. No. 61/708,084, filed Oct. 1, 2012, incorporated herein by reference, is hereby claimed.

### STATEMENTS AS TO THE RIGHTS TO THE INVENTION MADE UNDER FEDERALLY SPONSORED RESEARCH AND DEVELOPMENT

None

### BACKGROUND OF THE INVENTION

1. Field of the Invention

The present invention pertains to a camera and associated lighting system for use in well in unlighted and/or harsh environments. More particularly, the present invention pertains to a downhole illuminated camera systems for use in wells penetrating subterranean formations including, without limitation, oil and/or gas wells.

2. Brief Description of the Prior Art

Downhole camera systems exist for obtaining video and/or visual images in wells and wellbores. However, most wellbores contain no existing source of ambient or available light. Accordingly, a light source must typically be provided in order to illuminate downhole portions of a wellbore when use of a camera or other visual image sensor in such areas is desired.

Certain existing camera systems utilize some form of quartz lamp(s) to illuminate downhole portions of a wellbore for viewing. In one example, an incandescent light bulb is placed behind a camera body with a reflector. In another example, a low voltage, low power incandescent lamp is used to reduce the power requirements. Some existing downhole camera systems utilize an array of light-emitting diodes (LEDs) placed around the lens of cameras.

However, placing a light source behind a camera with a reflector typically leaves a large dark section caused by the body of the camera being positioned in front of the light source. In particular, as the size of a surrounding pipe is decreased, problems with existing light source systems typically increase. In smaller pipe, a camera acts as a light choke preventing light from entering into said camera's field of view.

Placing light bulbs or LEDs around a camera lens also causes several functional difficulties and other problems. Heat from lamps or LEDs typically causes electronic noise and damages the quality of the images coming from a camera. Additionally, shining light directly into fluids or at the top of an object to be viewed can also cause a back-scatter of light resulting in glare or white spots, further reducing the quality of captured images.

Moreover, well temperatures commonly exceed the temperature capabilities of conventional cameras or other image sensors. Methods to extend the operating temperature range and time at elevated temperatures commonly deploy vacuum heat shields and conventional insulating materials. However, such conventional means have proven to be less than optimal at addressing thermal limitations of cameras and/or other visual image sensors.

Conventional lighting designs deployed in borehole cameras are typically one of two types: (1) a light is positioned behind a camera or image sensor; or (2) a circular array comprising a ring light is positioned around a camera or image sensor. With the first option, light projecting from a rearward position tends to cast a distinct shadow on the inspection subject of interest, thereby reducing the quality of captured visual images. With the second option, bulk lamps and LED modules packaged around a camera add to the outside diameter of the imaging instrument, thereby limiting overall effectiveness and versatility, particularly in wells having relatively narrow internal diameters.

Oil and gas well and other industrial applications are best served by slim profiles that can traverse small tubing sizes and restrictions. However, housing a high-powered, high-heat dissipating light source within proximity to a temperature-sensitive camera, image sensor and/or associated electronics has represented a long standing design challenge.

Thus, there is a need for a slim-profile illuminated camera assembly that can be beneficially used in well bores or other environments lacking sources of ambient or available light. The illuminated camera assembly should be robust enough to function in harsh or difficult environments, and should beneficially illuminate a subject of interest in order to improve the quality of captured visual images. Further, the illuminated camera assembly should permit a high-powered, high-heat dissipating light source to be housed within proximity to a temperature-sensitive camera, image sensor and/or associated electronics without affecting or degrading performance thereof.

### SUMMARY OF THE INVENTION

The present invention comprises a method and apparatus for acquisition and transmission of visual images in a downhole environment. By way of illustration, but not limitation, the present invention comprises a camera system for downhole visual inspection of wellbores including, without limitation, oil and/or gas wells. The present invention reduces and/or eliminates problems encountered with conventional downhole camera assemblies and, more particularly, lighting systems use to illuminate environments for such cameras.

In a preferred embodiment, the present invention comprises a pressure housing containing a plurality of flasked sections (typically two): a camera flask section and a light flask section. The light flask section of the present invention comprises an LED, or an array of LEDs, disposed within a parabolic reflector located within a vacuumed flask. Said LED or array is pointed toward a glass light pipe, or a reflective polished spherical component that reflects such light toward said light pipe. The light generated by the light source is conveyed through said glass light pipe, typically along the outside of the vacuumed tube and past a camera section, to the distal end of the assembly.

At the distal end of the assembly, light coming via the light pipe is directed with a polished, beveled light diffuser. Such light is diffused around the bottom of the tool and downward such that the all or most of the surrounding environment (for example, a section of pipe disposed within a well) within the camera viewing area is evenly illuminated. In this manner, light can be emitted around and out past the camera lens and pressure port, and into the field of view of the camera.

Within said pressure housing, the camera flask is coupled to the light flask via a thermal insulating barrier or isolator. Internal and at its distal end of said camera flask is a double paned optic window having a vacuumed section between the glass panes. In a preferred embodiment, a small orientation sphere is disposed between said glass panes; said sphere is loose and able to roll freely as the camera assembly is rolled or otherwise moved. The orientation sphere is beneficially placed within the outer perimeter of the camera's field of view to give a visual indication of the low side of a non-vertical well bore.

In one embodiment, the camera flask and the light flask each include heat sinks which beneficially comprise compounds designed to absorb heat and retain such heat within each flask. In the case of the camera flask, the purpose of a heat sink is to draw and store heat penetrating such flask in order to maintain an acceptable operating temperature for the camera. Within the light flask, said heat sink is designed to pull heat from the LED driver electronics and LED and keep said heat internal and away from the camera.

The benefits of the present invention include, without limitation, providing light through a light pipe to a viewing area while eliminating hot or white spots. The present invention also reduces glare and reflection caused by pointing LED's or other forms of lighting directly toward a downhole object to be viewed. Unlike existing back-lighted cameras, the light is emanating directly into the entire field of view, and no dark spot or section is caused by the camera body. The illuminated camera system of the present invention is beneficially slim, and capable of working in a full range of pipe sizes.

The vacuum flasks utilized in the present invention keep heat generated by the LED's and/or other light source(s), as well as wellbore heat, away from said camera. The end result is a smaller diameter camera assembly able to work in hotter wellbores than conventional downhole cameras that is also capable of providing better quality visual images.

The present invention is a much improved oil and gas well camera with distinct innovative attributes. The image sensor or camera sub-assembly is enveloped within a single light pipe of tubular geometry. Other functional portions are enveloped in heat shields with thermal energy storage cartridges. The light pipe conveys light from a light source past an image sensor but reflects, conducts, stores, and dissipates heat away from temperature sensitive components, such as a camera/image sensor and electronics.

Further, the functional components of the present invention are beneficially enveloped within a hermetically sealed pressure resistant housing. The bulk-material cross-section carrying light of the present invention provides even illumination as opposed to gaps formed between tangents of bundled optical fibers. Effective coupling with minimal decibel losses is more easily achieved and instrument service difficulties are mitigated with the present invention.

The present invention can be conveyed into and out of a well on conventional electric line to allow for real-time data transmission. Further, the present invention can also be equipped with a battery and data-storage means; in such configuration, the present invention can be conveyed in and out of a wellbore via slick line, braided line or continuous (coiled) tubing. With such embodiments, the present invention can be conveyed through an area of interest via mechanical means with image data stored within internal memory. Such data can be downloaded and processed following retrieval of the present invention from the well.

### BRIEF DESCRIPTION OF DRAWINGS/FIGURES

The foregoing summary, as well as any detailed description of the preferred embodiments, is better understood when read in conjunction with the drawings and figures contained herein. For the purpose of illustrating the invention, the drawings and figures show certain preferred embodiments. It is understood, however, that the invention is not limited to the specific methods and devices disclosed in such drawings or figures.

FIG. 1 depicts a side sectional view of a first embodiment of the present invention.

FIG. 2 depicts a side sectional view of an alternative embodiment of the present invention.

FIG. 3 depicts a side sectional view of a second alternative embodiment of the present invention.

FIG. 4 depicts a side sectional view of a third alternative embodiment of the present invention.

FIG. 5 depicts a side sectional view of a fourth alternative embodiment of the present invention.

### DETAILED DESCRIPTION OF A PREFERRED EMBODIMENT

The present invention comprises a method and apparatus for acquisition and transmission of visual (still and/or video) images in a downhole environment. By way of illustration, but not limitation, the present invention comprises a camera system for downhole visual inspection of wellbores including, without limitation, oil and/or gas wells. The method and apparatus of the present invention reduce and/or eliminate problems observed with conventional downhole camera assemblies and, more particularly, lighting systems use to illuminate environments for capturing visual images by such cameras.

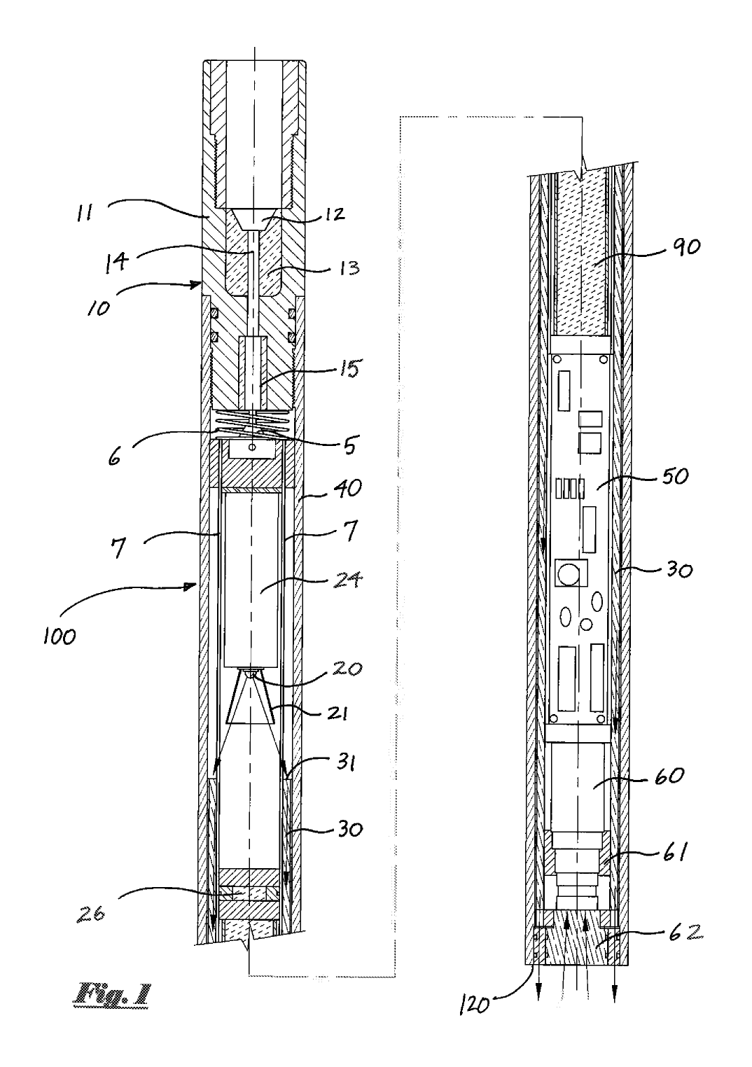

FIG. 1 depicts a side sectional view of a first embodiment of an illuminated camera assembly 100 of the present invention. Although additional embodiments can be envisioned, in the embodiment depicted in the appended drawings said illuminated camera assembly 100 of the present invention is adapted to be conveyed into and out of a well bore via conventional electric line.

Illuminated camera assembly 100 of present invention can be conveyed into and out of a well on conventional electric line to advantageously allow for real time data transmission in and out of said well. Alternatively, it is to be observed that said illuminated camera assembly 100 can also be equipped with a battery and data-storage means without departing from the scope of the present invention; in such a configuration, the present invention can be conveyed in and out of a wellbore via slick line, braided line or continuous (coiled) tubing.

Still referring to FIG. 1, the embodiment depicted in FIG. 1 is adapted for connection to a conventional electric line connector assembly such as, for example, single conductor wireline connector assembly 10. By way of illustration, said single conductor wireline connector 10 generally comprises connection sub body 11, spring pin receptacle 12, insulator 13, connection rod 14 and receptacle 15 for chassis pin contact. Said single conductor wireline connector 10 is known to those having skill in the art of wireline wellbore operations, such as operations utilizing electric line.

In a preferred embodiment, the present invention comprises electrical pin contact member 5 and compression spring 6 disposed within hermetically sealed outer pressure housing 40. Said compression spring 6 provides axial force to beneficially bias electrical components and optical interfaces of the present invention together for improved performance. Wire conduits 7 are beneficially provided to allow for the transmission of power and/or data through the assembly of the present invention in order to power and/or control various electronic components of illuminated camera assembly 100.

At least one light source, such as LED 20 controlled by LED control electronics 24 is provided to generate light. It is to be observed that an array of LED's, or other light source having desired characteristics, can also be used for this purpose. As depicted in FIG. 1, said LED 20 is disposed within a reflector, such as convergent parabolic reflector 21. Said light source, control electronics and reflector can also be beneficially wrapped within a vacuum heat shield or insulating wrap 22 (not depicted in FIG. 1).

Light generated by LED 20 is pointed or otherwise directed toward end coupling 31 of substantially tubular glass light pipe 30; said end coupling 31 serves as a light collector for light pipe 30. Said glass light pipe 30 transmits such light generated by LED 20 along substantially the entire length of the apparatus to distal end 120 of the assembly as described more fully below.

As depicted in the embodiment shown in FIG. 1, illuminated camera assembly 100 of the present invention further comprises thermal insulation barrier assembly 26 and printed circuit board 50. Although other embodiments can be envisioned, in a preferred embodiment said printed circuit board 50 can be disposed on a rugged metallic chassis.

Still referring to FIG. 1, latent heat storage (“LHS”) member 90 is disposed between said thermal insulation barrier assembly 26 and printed circuit board 50. In a preferred embodiment, said LHS member 90 comprises a phase-change material (“PCM”), such as a substance with a high heat of fusion which is capable of storing and releasing energy.

Further, said illuminated camera assembly 100 comprises camera 60 for capturing visual still or video images. Still referring to FIG. 1, said camera 60 is centralized within light pipe 30 using camera centralizer 61. A high pressure camera lens assembly 62 is provided at or near distal end 120 of said illuminated camera assembly 100.

Light pipe 30 extends along substantially the entire length of illuminated camera assembly 100 of the present invention. At distal end 120, light conveyed via light pipe 30 can be directed into a surrounding environment (such as a wellbore or the like). In one embodiment, such light can be further diffused into said surrounding environment using an optional polished beveled light diffuser, typically disposed at or near distal end 120. Such light is beneficially directed substantially downward and diffused such that the entire area (for example, a section of pipe) within a viewing area of camera 60 is illuminated. In this manner, light can be emitted around and out past the camera lens and pressure port, and into the field of view of camera 60.

The benefits of the present invention include, without limitation, providing light through light pipe 30 to a viewing area while eliminating hot or white spots. Illuminated camera assembly 100 of the present invention also reduces glare and reflection caused by pointing LED's or other light sources directly toward a target or object to be viewed. Unlike existing back-lighted cameras, the light is emanating directly into the entire field of view, and no dark spot or section is caused by the camera body. Illuminated camera assembly 100 of the present invention is capable of working in a full range of pipe sizes, including wells having small internal diameter pipe.

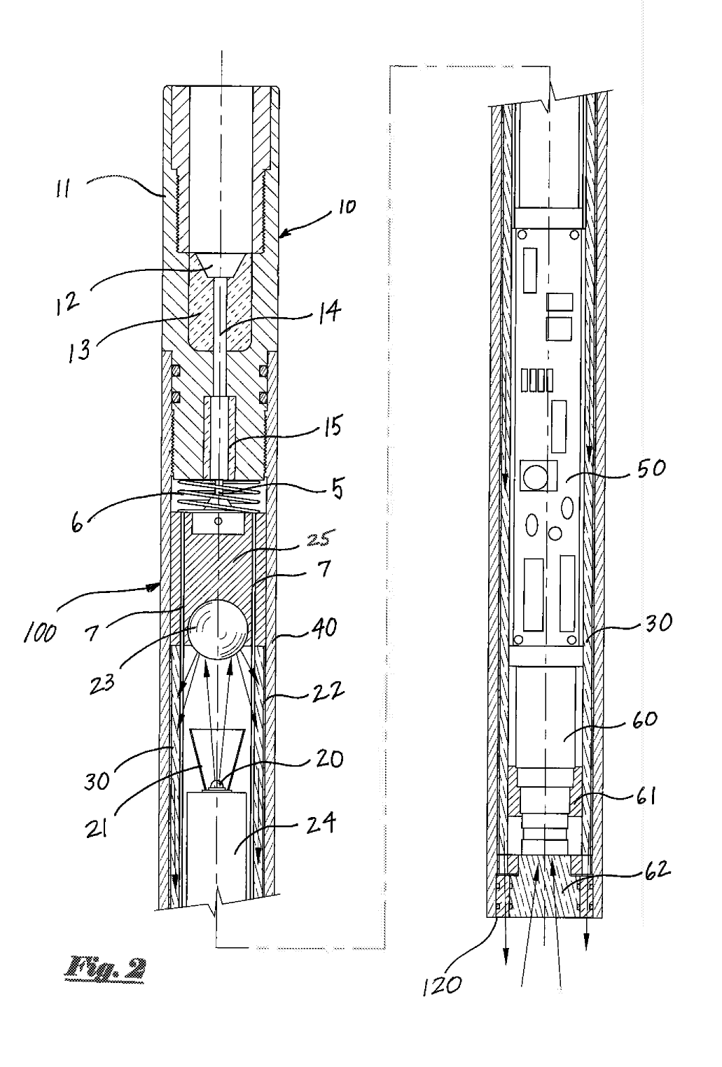

FIG. 2 depicts a side sectional view of an alternative embodiment of illuminated camera assembly 100 of the present invention. Light generated by LED 20 is pointed or otherwise directed toward polished divergent reflector sphere 23. As depicted in FIG. 2, thermal insulation material 25 is provided above said divergent reflector sphere 23. Light generated by LED 20 reflects from said reflector sphere 23 toward substantially tubular glass light pipe 30. Said glass light pipe 30 then transmits such light along the outside of vacuum flask 22 to distal end of the assembly 120.

The present invention can comprise a white thermally-conductive spherical divergent back-reflector to couple a portion of radiated heat into a heat sink opposite the direction of visible reflected light, especially light having wavelengths associated with the infrared and ultraviolet spectrum.

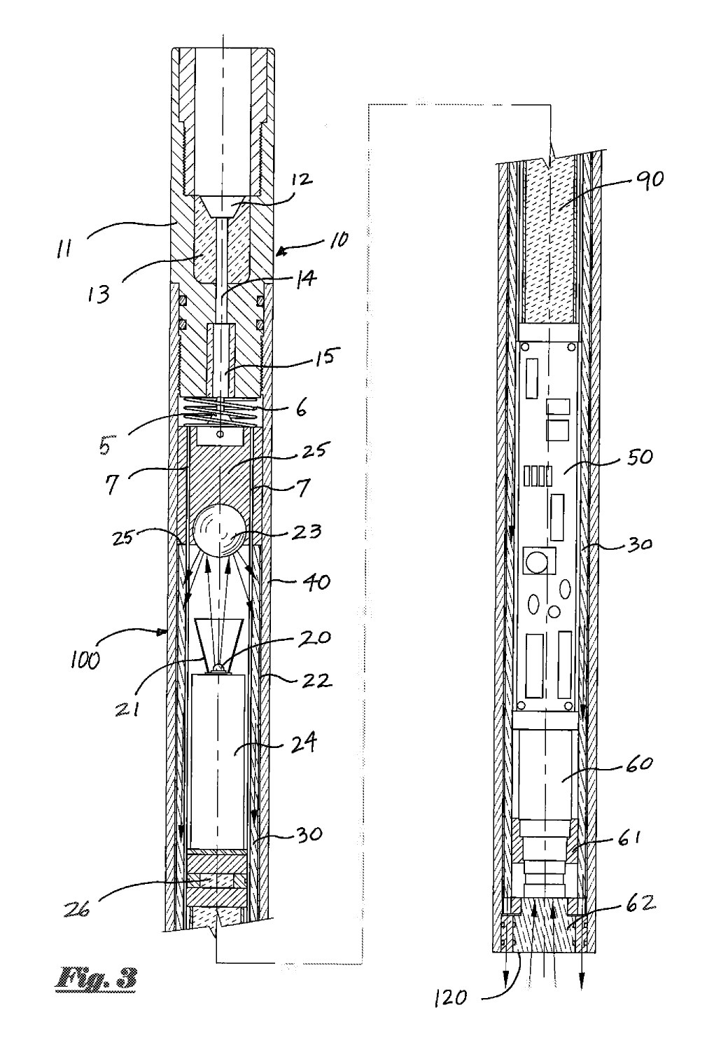

FIG. 3 depicts a side sectional view of a second alternative embodiment of illuminated camera assembly 100 of the present invention. In the embodiment depicted in FIG. 3, light generated by LED 20 is pointed or otherwise directed toward polished divergent reflector sphere 23. Thermal insulation material 25 is provided above said divergent reflector sphere 23. Light generated by LED 20 reflects from reflector sphere 23 toward substantially tubular glass light pipe 30. Said glass light pipe 30 then transmits such light along the outside of vacuum flask 22 to distal end of the assembly 120. LHS member 90 is disposed between said thermal insulation barrier assembly 26 and printed circuit board 50. In a preferred embodiment, said LHS member 90 comprises a phase-change material (“PCM”), such as a substance with a high heat of fusion which is capable of storing and releasing energy.

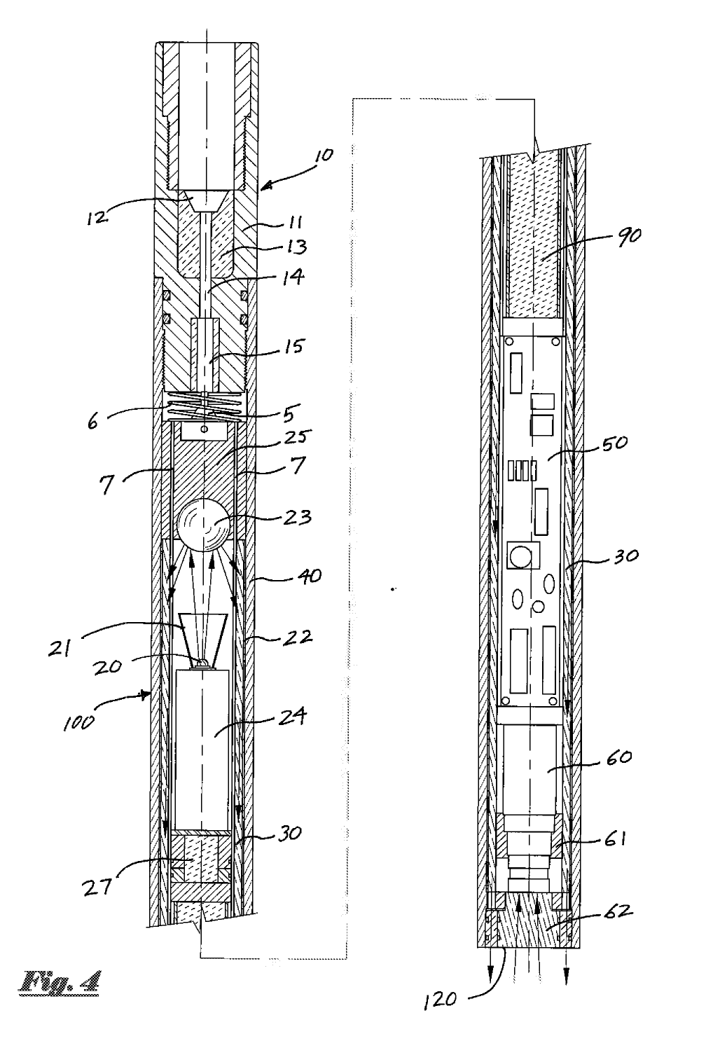

FIG. 4 depicts a side sectional view of a third alternative embodiment of illuminated camera assembly 100 the present invention. In the embodiment depicted in FIG. 4, light generated by LED 20 is pointed or otherwise directed toward polished divergent reflector sphere 23. Thermal insulation material 25 is provided above said divergent reflector sphere 23. Light generated by LED 20 reflects from reflector sphere 23 toward substantially tubular glass light pipe 30. Said glass light pipe 30 then transmits such light along the outside of vacuum flask 22 to distal end of the assembly 120. LHS member 90 is disposed between alternative thermal insulation barrier assembly 27 and printed circuit board 50. In a preferred embodiment, said LHS member 90 comprises a PCM, such as a substance with a high heat of fusion which is capable of storing and releasing energy.

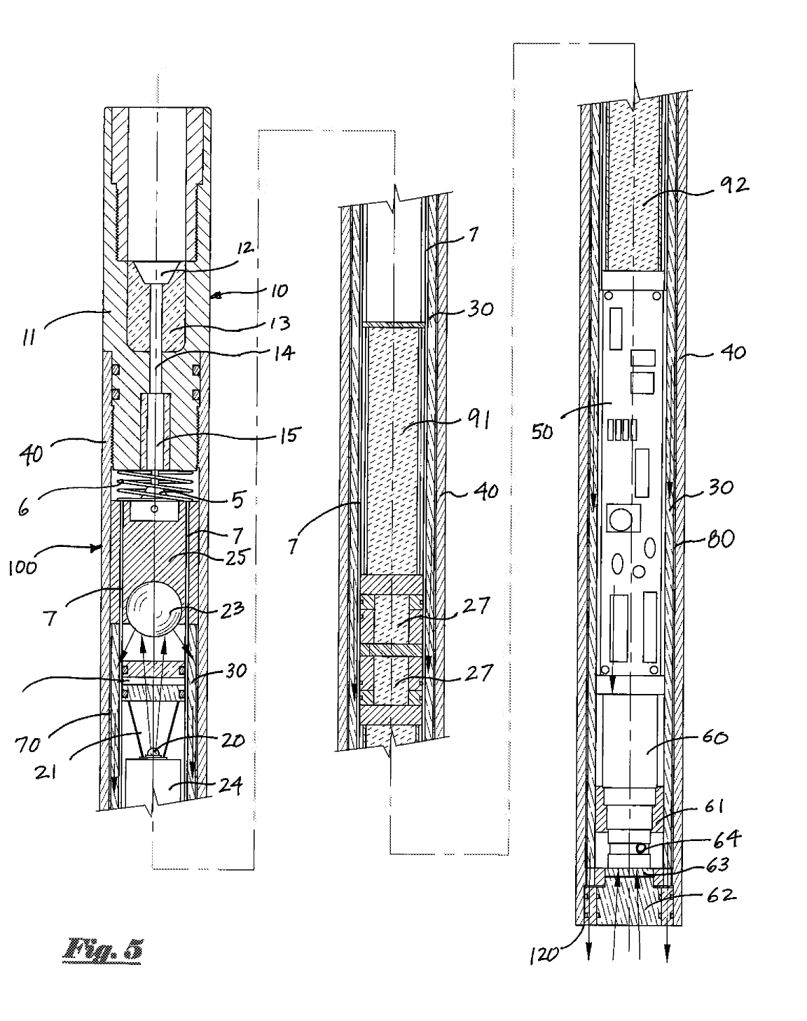

FIG. 5 depicts a side sectional view of a fourth alternative embodiment of illuminated camera assembly 100 of the present invention. In the embodiment depicted in FIG. 5, illuminated camera assembly 100 of the present invention comprises an outer fluid pressure sealed housing 40 containing a plurality of flasked assemblies: a camera assembly disposed within vacuum camera flask 80 and a light assembly disposed with vacuum flask 70. In this embodiment, a vacuum heat shield lens assembly 63 can be provided for camera 60.

Within outer pressure housing 40, vacuum camera flask 80 is joined or coupled to said vacuum light flask 80 via a thermal barrier that functionally accommodates a significant heat differential between said camera and light components.

Still referring to FIG. 5, internal and at the distal end of said camera flask is a double paned optic window having a vacuumed section between said glass panes. In a preferred embodiment, a relatively small orientation ball or sphere 64 is disposed between said glass panes; said sphere is loose and able to roll freely as the camera assembly is rolled or otherwise moved within a wellbore. Said orientation sphere 64 is beneficially placed within the outer perimeter of the field of view of camera 60 to give a visual indication of the low side of a non-vertical well bore as a simple, inexpensive, robust and compact alternative to conventional accelerometers and/or support electronics. If needed, illumination provided by the present invention can also be at least partially directed toward said sphere 64.

Both the camera flask and the light flasks include heat sinks which beneficially comprise materials designed to absorb heat and retain such heat within each flask. In the case of the camera flask, a purpose of a heat sink is to draw any heat coming into the flask away from the camera. Within the light flask, a purpose of said heat sink is to isolate heat from electronic components and LED, and to keep such thermal energy away from the camera. In the embodiment depicted in FIG. 4, LHS member 91 is provided for said light flask, while LHS member 92 is provided for said camera flask. Said LHS members 91 and 92 can comprise a PCM, such as a substance with a high heat of fusion which is capable of storing and releasing energy.

The distinct flasks utilized in illuminated camera assembly 100 of the present invention keep heat being generated by the LED's, other light source(s) and/or supporting electronics, as well as heat from the wellbore, away from said camera. This allows for a smaller diameter camera assembly able to work in smaller and hotter wellbores than conventional camera assemblies, while yielding better quality visual images.

As noted above, the image sensor or camera sub-assembly of the present invention is enveloped within a single light pipe of substantially tubular geometry. Other functional components are enveloped within, or otherwise protected by, heat shields having thermal energy storage components using strategically positioned endothermic PCM's. Said light pipe conveys light from a source past the image sensor or camera for illumination of the surrounding environment, but reflects, sinks, conducts, stores, exchanges and/or dissipates heat away from temperature-sensitive components of the present invention including, without limitation, image sensor/camera and electronics.

Referring back to FIG. 1, light is directed into end 31 of light pipe 30 without divergent back-reflection and concentration to permit greater intensity. Any additional directly radiated heat can be addressed using heat management measures described more fully herein including, without limitation, those described in connection with the embodiments depicted in FIGS. 2 through 5 (and/or combinations thereof). As such, it is to be observed that such direct light pipe coupling may apply separately and equally to the alternative embodiments of FIGS. 2 through 5.

The bulk-material cross-section light conveyance system of the present invention represents a significant improvement over conventional light conveyance means, such as light conveyed via bundled optical fibers which can create gaps between tangents of said bundled optical fibers. Effective coupling with minimal decibel losses is more easily achieved and instrument service difficulties are mitigated with the illuminated camera assembly of the present invention.

The illuminated camera assembly of the present invention permits a high-powered, high-heat dissipating light source to be housed within proximity to (such as in the same tubular housing with) a temperature-sensitive camera, image sensor and/or associated electronics, without negatively affecting or degrading performance thereof.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

1. A wellbore illumination and visual sensor assembly comprising:
a) a light source;
b) a substantially tubular light pipe having first end, a second end and a central bore extending there through; and
c) a visual sensor having a view field, wherein said sensor is disposed within said central bore, and light from said light source is conveyed via said light pipe past said visual sensor to illuminate said field of view.

2. The wellbore illumination and visual sensor assembly of claim 1, wherein said light source comprises at least one light emitting diode.

3. The wellbore illumination and visual sensor assembly of claim 1, wherein said second end of said tubular light pipe comprises a beveled light diffuser.

4. The wellbore illumination and visual sensor assembly of claim 1, wherein said light source is aimed substantially toward said first end of said light pipe.

5. The wellbore illumination and visual sensor assembly of claim 1, wherein said light source is aimed substantially toward a reflector adapted to reflect light substantially toward said first end of said light pipe.

6. The wellbore illumination and visual sensor assembly of claim 5, wherein said reflector is at least partially spherical in shape.

7. The wellbore illumination and visual sensor assembly of claim 1, further comprising at least one thermal insulation barrier disposed between said light source and said visual sensor.

8. The wellbore illumination and visual sensor assembly of claim 1, further comprising at least one latent heat storage assembly disposed between said light source and said visual sensor.

9. The wellbore illumination and visual sensor assembly of claim 8, wherein said at least one latent heat storage assembly comprises at least one substance with a high heat of fusion that is capable of storing and releasing energy.

10. The wellbore illumination and visual sensor assembly of claim 1, further comprising:
a) a double paned optic window; and
b) a free-rolling ball disposed between said panes.

11. A wellbore illumination and video camera assembly comprising:
a) a pressure sealed housing having a first end, a second end and a length;
b) a substantially tubular light pipe having first end, a second end and a central bore extending there through, disposed within said housing;
c) a light source disposed within said housing; and
d) a video camera having a view field, wherein said video camera is disposed within said housing, and light from said light source is conveyed via said light pipe past said visual video camera to illuminate said field of view.

12. The wellbore illumination and video camera assembly of claim 11, wherein said light source comprises at least one light emitting diode.

13. The wellbore illumination and video camera assembly of claim 11, wherein said second end of said tubular light pipe comprises a beveled light diffuser.

14. The wellbore illumination and video camera assembly of claim 11, wherein said light source is aimed substantially toward said first end of said light pipe.

15. The wellbore illumination and video camera assembly of claim 11, wherein said light source is aimed substantially toward a reflector adapted to reflect light substantially toward said first end of said light pipe.

16. The wellbore illumination and video camera assembly of claim 15, wherein said reflector is at least partially spherical in shape.

17. The wellbore illumination and video camera assembly of claim 11, further comprising at least one thermal insulation barrier disposed between said light source and said video camera.

18. The wellbore illumination and video camera assembly of claim 11, further comprising at least one latent heat storage assembly disposed between said light source and said video camera.

19. The wellbore illumination and video camera assembly of claim 18, wherein said at least one latent heat storage assembly comprises at least one substance with a high heat of fusion that is capable of storing and releasing energy.

20. The wellbore illumination and video camera assembly of claim 11, further comprising:
a) a double paned optic window; and
b) a free-rolling ball disposed between said panes.
